(19) United States
(12) Patent Application Publication
(10) Pub. No.: US 2016/0045926 A1
(43) Pub. Date: Feb. 18, 2016

(54) ABRADABLE COATINGS FOR GAS TURBINE ENGINE COMPONENTS

(71) Applicant: PRATT & WHITNEY CANADA CORP., Longueuil (CA)

(72) Inventor: Kin-Leung CHEUNG, Toronto (CA)

(21) Appl. No.: 14/458,471

(22) Filed: Aug. 13, 2014

(51) Int. Cl. B05B 17/06; B05D 1/12; F01D 11/12; B05B 7/14

(52) U.S. Cl. CPC B05B 17/06; B05B 7/1404; B05D 1/12; F01D 11/122; F05D 2220/32; F05D 2230/10; F05D 2230/31; F05D 2240/31; F05D 2240/55

(57) ABSTRACT

A process for forming an abradable coating on a component of a gas turbine engine includes providing a particulate mixture including an abradable coating material in particle form, the abradable material including at least a solid lubricant, and applying the particulate mixture containing the abradable coating material onto the component using pulsed shockwaves carrying the particular mixture, while maintaining a temperature of the particular mixture below a threshold temperature above which the solid lubricant in the abradable material substantially reacts chemically.

### TECHNICAL FIELD

The invention relates generally to gas turbine engines, and, more particularly, to abradable coatings on gas turbine engine components and the method of applying such coatings.

### BACKGROUND

The provision of abradable seals, in the compressor or turbine section of a gas turbine engine for example, is known. For instance a rotor made up of a plurality of blades is contained within a shroud surrounding the blade tips. A coating of abradable material is provided on the inner surface of the surrounding shroud, and as the rotor rotates, the blades expand due to the heat which is generated during operation of the engine, causing the tips of the rotating blades to contact the abradable material coating and carve precisely defined grooves in the coating without contacting the shroud itself.

The material making up the abradable seal must be such as to avoid wearing the rotor blade tips while at the same time preventing mitigation of the seal matrix material from the seal to the rotor blades. These coatings may be applied by thermal sprays including plasma, or using cold sprays. The inclusion of solid lubricants, in the abradable coating, have been a challenge. Thermal sprays are deleterious to the solid lubricant. In the case of a cold spray, the spray deposition of the lubricant particles into the coating is not achievable. A thermal spray generally decomposes the lubricant and destroys its crystalline structure and/or the matrix coating particles reacts with the lubricant particles and forms deleterious reaction products.

There is therefore a continuing need for improved abradable coatings and the methods for providing such coatings.

### SUMMARY

There is provided a process for forming an abradable coating to a component of a gas turbine engine, the process comprising: providing a particulate mixture including an abradable coating material in particle form, the abradable material including at least a solid lubricant; and applying the particulate mixture containing the abradable coating material onto the component using pulsed shockwaves carrying the particular mixture, including directing the pulsed shockwaves toward, and impacting the pulsed shockwaves on, the component, while maintaining a temperature of the particular mixture below a threshold temperature above which the solid lubricant in the abradable material substantially reacts chemically.

There is also provided a process for forming an abradable coating on a surface of a component of a gas turbine engine, the process comprising directing pulsed shockwaves carrying an abradable particle mixture onto the surface, the abradable particle mixture including a solid lubricant, and injecting a supplement of the solid lubricant into the pulsed shockwaves to provide additional lubricant material in the abradable coating applied to the surface of the component.

There is further provided an apparatus for applying an abradable coating to a surface of a component of a gas turbine engine, the apparatus comprising a low-temperature shockwave generator, a delivery tube communicating with the shockwave generator at a proximal end and having an open distal end, and a valve interrupting the communication between the shockwave generator and the delivery tube to produce a pulsed shockwave moving through the delivery tube to the open distal end and impacting on the surface of the component, the delivery tube including at least an inlet for injecting an abradable mixture in particle form into the delivery tube to be carried by the pulsed shockwave to the surface of the component.

In accordance with another aspect, there is also provided a method of depositing an abradable coating from powders including at least a solid lubricant powder, to the surface of a component; the method includes the steps of generating a low-temperature, non-detonation, pulsed shockwave to be passed through a tubular member and injecting an abradable coating material in particle form into the tubular member to be carried by a pulsed shockwave to be deposited on the surface of the component.

In another aspect of the method, selected amounts of the solid lubricant powder are injected in the tubular member during the step of depositing the powders by pulsed shockwave spray. In a more specific embodiment of the method, the solid lubricant powder includes hexagonal boron nitride.

An apparatus is also provided, comprising a low-temperature shockwave generator, a delivery tube communicating with the shockwave generator and a valve interrupting the communication between the shockwave generator and the delivery tube to produce a pulsed shockwave moving through the delivery tube to its outlet and impacting on a component to be coated; at least an inlet provided on the delivery tube for injecting an abradable mixture in particle form into the delivery tube to be carried by the pulsed shockwave onto the component to be coated.

In another aspect of the apparatus, a second inlet is provided on the delivery tube for injecting a supplementary solid lubricant in particle form into the delivery tube to also be carried by the pulsed shockwave.

### DESCRIPTION OF THE DRAWINGS

Reference is now made to the accompanying figures, in which:

FIG. 1 is a schematic cross-section of a gas turbine engine;

FIG. 2 is an enlarged fragmentary, cross-sectional view of a detail of the engine shown in FIG. 1;

FIG. 3 is a further enlarged view of the detail shown in FIG. 2 showing an abradable coating deposited on a component; and

FIG. 4 is a schematic diagram of a device for depositing abradable powder on the component.

### DETAILED DESCRIPTION

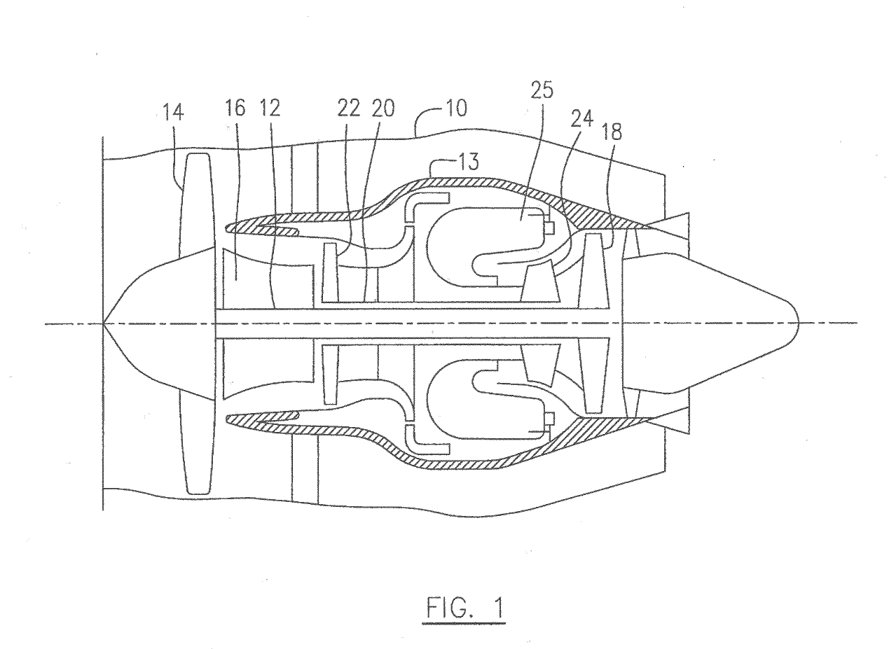

FIG. 1 illustrates a turbofan gas turbine engine which includes a housing or nacelle 10, a core casing 13, a low pressure spool assembly seen generally at 12 which includes a fan assembly 14, a low pressure compressor assembly 16 and a low pressure turbine assembly 18, and a high pressure spool assembly seen generally at 20 which includes a high pressure compressor assembly 22 and a high pressure turbine assembly 24. The core casing 13 surrounds the low and high pressure spool assemblies 12 and 20 in order to define a main fluid path therethrough. In the main fluid path, there is provided a combustor seen generally at 25.

Referring to FIGS. 1-3, abradable coatings as described herein may be applied to engine casings, blade shrouds (either compressor or turbine), and other components of the gas turbine engine, in order to improve turbine engine performance.

As noted above, in the past abradable coatings have generally been applied by thermal sprays including plasma, as described in U.S. Pat. No. 5,434,210 issued Jul. 18, 1995 to Rangaswamy et al and assigned to Sulzer Plasma Tecnicks, Inc., or using cold sprays as described in U.S. Pat. No. 6,365,222 to Wagner et al, issued on Apr. 2, 2002, the entire contents of which are incorporated herein by reference.

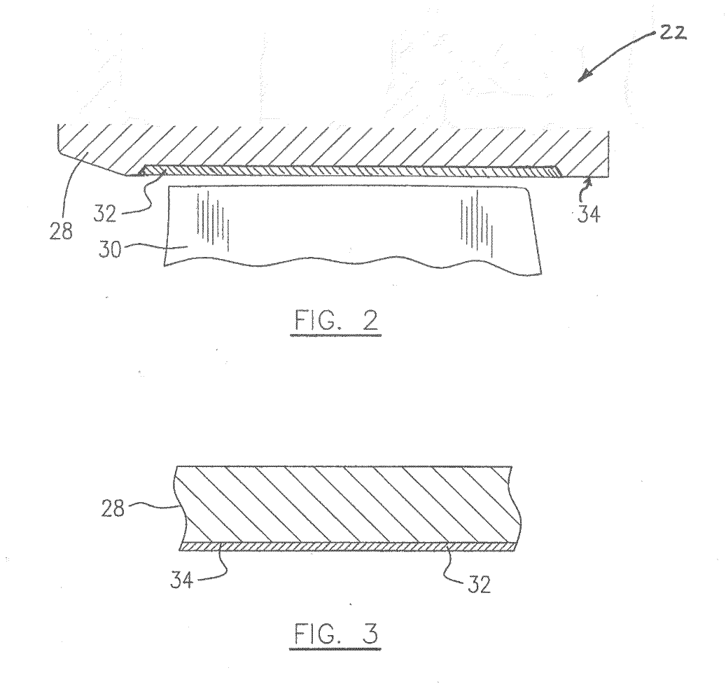

In the present disclosure, and referring generally to FIGS. 2-3, a shroud segment 28 of the annular shroud ring in the high pressure compressor assembly 22 is shown surrounding the tips of the high pressure compressor blades 30, and having an abradable coating layer 32 thereon on the inner surface of the shroud segment 28. This inner surface of the shroud segment may be, for example, an air path surface 34 of the shroud segment 28. The abradable coating layer 32 allows blade rubbing to form a tight sealing surface around the tips of the blades 30, thereby reducing and minimizing air leakages through the gaps between the blade tips and shrouds. The abradable coating layer 32 is typically designed to wear and fray in preference to the blades 30 wearing or fretting, in order to avoid blade damage and wear and to thereby avoid expensive protective treatment and/or unnecessary repairs to the blades.

While the abradable coating layer 32 is described herein as applied to a shroud segment of the compressor of the engine, it is to be understood that the present abradable coating layer 32 can similarly be formed on the turbine shrouds surrounding one or more turbine rotors in the turbine section of the gas turbine engine.

It is common to use a Sulzer Metco 320 abradable coating mixture when coating a shroud. The powder mixture includes a lubricant such as Hexagonal Boron Nitride. In the case of thermal or plasma spraying methods of the Sulzer Metco material, the titanium blades 30 rub against the abradable coating 32 and material from the coating transfers and sticks to the blade tips creating “corduroy” leak paths in the coating 32. It is believed that this phenomenon is caused by the reduction of the solid lubricant, such as Hexagonal Boron Nitride used in the Sulzer Metco mix to prevent material transfer to the blades, through oxidation due to the high heat. Other factors, resulting from the high heat, include decomposition losses from the reaction with aluminum alloy, in the powder mix, forming aluminum nitride. Cold spray depositions are incapable of depositing solid lubricants such as Hexagonal Boron Nitride in coatings.

U.S. Pat. No. 8,298,612 to Jodoin, the entire content of which is incorporated herein by reference, describes an apparatus and method for the deposition of solid particles on a substrate to form a coating by way of a shockwave projecting the solid particles on the surface of the substrate. Jodoin relies on a shockwave generator in which a gas pressure is built up and released, by means of a valve, into a spray tube creating a shockwave to carry the particle material to the substrate to be coated. Although Jodoin mentions the process may use auxiliary heating to preheat the particles up to 1,200° C., it is possible to deliver the particles at a much lower temperature to avoid loss of the lubricant such as Hexagonal Boron Nitride. Other known shockwave delivery devices rely on detonation to produce the shock or compression wave. These methods fall in the category of thermal delivery systems having excessive high temperature.

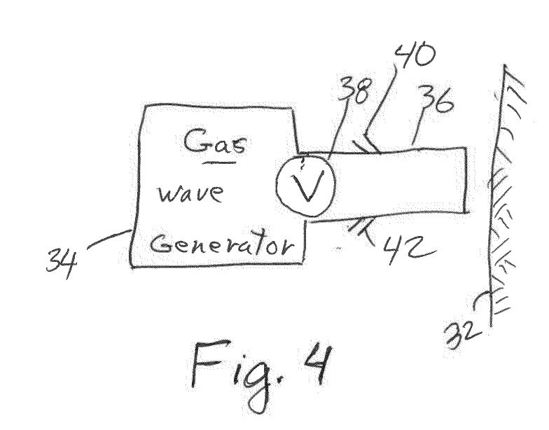

FIG. 4 illustrates, schematically, a system of using a shockwave generator 34 communicating with a delivery, spray tube 36, for the purposes of applying the present abradable coating. A valve 38 may be provided to intermittently release a shockwave into the delivery tube 36, e.g. creating a pulsed shockwave. Inert gases may be provided in the generator 34 and are being compressed to be released into the delivery tube 36 and to carry a particle or powder mix towards the shroud component 32 to form the abradable coating. The gases should be at least inert to the particles in the particle mix.

It has also been found that supplementing the amount of lubricant during the deposition process, not only replaces any loss of lubricant but may enhance the performance of the abradable coating from preventing the transfer of the coating material from the shroud component to the blade tip.

In one example, a first stream of an abradable particle mix, such as Sulzer Metco 320 powder, is fed into the delivery tube 36 through an inlet 40 to form the base abradable coating. A supplement of Hexagonal Boron Nitride powder is fed into the tube 36 through inlet 42. The shockwave spray can deposit the supplementary dry lubricant powder of layered structure held by weak van der Waals forces as the inter-particle spacing of pulsed shockwave spray are much smaller than in a cold-spray process because powder particles inside the tube 36 are compacted by a plurality of shockwaves/compression waves before exit. (In the cold spray process, the shape of the cold spray nozzle disperses the powder particles as they exit from the tube that further increases the inter-particles spacing.) When the Hexagonal Boron Nitride particles impact the shroud component 32 the particles shatter due to shear. The particles collide instantaneously with oncoming particles in the spray and get captured in the coating before the particles can scatter and escape.

The amount of supplemental Hexagonal Boron Nitride may vary through the thickness of the coating but in a preferred embodiment, from 1% to 3% weight of lubricant powder is injected into the spray stream at progressively increasing amounts, starting from about 0.010″ to 0.015″ (0.254 mm to 0.38 mm) below the gas path surface of the finished coating. In other words if the total mix is 100 grams, the ratio would be 1 g Hexagonal Boron Nitride to 99 g; and 3 g Hexagonal Boron Nitride to 97 g of the remainder of the powder being deposited.

During the spraying process, the temperature threshold should not exceed 550° C. to avoid aluminum from reacting with boron nitride to form aluminum nitride. Furthermore, above 1000° C. oxidation of boron nitride occurs. It is therefore desirable to maintain the temperature below 550° C. during the spraying process, in order to prevent the solid lubricant in the abradable material from chemically reacting.

The above description is meant to be exemplary only, and one skilled in the art will recognize that changes may be made to the embodiments described without departure from the scope of the inventions disclosed. For example, a shroud segment in a high pressure compressor assembly of the engine was described as an example of the application of the present invention; however the present teachings may be applied to any suitable application requiring abradable coatings. Although Hexagonal Boron Nitride is proposed, other equivalent solid lubricants may be substituted. Still other modifications will be apparent to those skilled in the art, in light of a review of this disclosure, and such modifications are intended to fall within the scope of the claims.

What is claim is:

1. A process for forming an abradable coating to a component of a gas turbine engine, the process comprising:
providing a particulate mixture including an abradable coating material in particle form, the abradable material including at least a solid lubricant; and
applying the particulate mixture containing the abradable coating material onto the component using pulsed shockwaves carrying the particular mixture, including directing the pulsed shockwaves toward, and impacting the pulsed shockwaves on, the component, while maintaining a temperature of the particular mixture below a threshold temperature above which the solid lubricant in the abradable material substantially reacts chemically.

2. The process defined in claim 1, wherein the shockwaves are generated without detonation means.

3. The process as defined in claim 1, wherein the component is a shroud forming part of a casing surrounding a rotor.

4. The process as defined in claim 1, wherein a supplement of the solid lubricant is independently injected into the tubular member.

5. The process as defined in claim 1, wherein the solid lubricant is hexagonal boron nitride.

6. The process as defined in claim 5 wherein the hexagonal boron nitride is injected in a proportion of 1% to 3% by weight of the abradable coating material in particle form.

7. The process as defined in claim 6, wherein the hexagonal boron nitride is initially injected from about 0.254 mm to about 0.38 mm below the gas path surface of the finished abradable coating.

8. A process for forming an abradable coating on a surface of a component of a gas turbine engine, the process comprising directing pulsed shockwaves carrying an abradable particle mixture onto the surface, the abradable particle mixture including a solid lubricant, and injecting a supplement of the solid lubricant into the pulsed shockwaves to provide additional lubricant material in the abradable coating applied to the surface of the component.

9. The process as defined in claim 8, wherein the component is a shroud surrounding a rotor in the gas turbine engine and the surface of the shroud is the gas path surface surrounding the blade tips of the rotor.

10. The process as defined in claim 9 wherein the additional lubricant material is disposed proximate the surface.

11. The process as defined in claim 10, wherein the solid lubricant material is hexagonal boron nitride.

12. The process as defined in claim 11, wherein the hexagonal boron nitride is injected in a proportion of 1% to 3% by weight of the abradable particulate material.

13. The process as defined in claim 11, wherein the hexagonal boron nitride is initially injected from about 0.254 mm to 0.38 mm below the surface.

14. An apparatus for applying an abradable coating to a surface of a component of a gas turbine engine, the apparatus comprising a low-temperature shockwave generator, a delivery tube communicating with the shockwave generator at a proximal end and having an open distal end, and a valve interrupting the communication between the shockwave generator and the delivery tube to produce a pulsed shockwave moving through the delivery tube to the open distal end and impacting on the surface of the component, the delivery tube including at least an inlet for injecting an abradable mixture in particle form into the delivery tube to be carried by the pulsed shockwave to the surface of the component.

15. The apparatus as defined in claim 14, wherein a second inlet is provided on the delivery tube for injecting a supplementary solid lubricant in particle form into the delivery tube to also be carried by the pulsed shockwave towards the surface of the component to be coated.

16. The apparatus as defined in claim 14, wherein the shockwave generator is provided with gases inert to the particles to be delivered.
